(19) United States
(12) Patent Application Publication
(10) Pub. No.: US 2026/0368517 A1
(43) Pub. Date: Nov. 19, 2026

(54) Translatable Micro Models In Small Memory Embedded Systems

(71) Applicant: American Megatrends International, LLC, Duluth, GA (US)

(72) Inventors: Chitrak Gupta, Johns Creek, GA (US); Manoj Kumar P, Panruti (IN); Varadachari Sudan Ayanam, Suwanee, GA (US); Chin-Sung Lo, New Taipei City (TW)

(21) Appl. No.: 19/210,267

(22) Filed: May 16, 2025

(51) Int. Cl. G06N 3/08; G06N 3/048

(52) U.S. Cl. CPC G06N 3/08; G06N 3/048

(57) ABSTRACT

In an aspect of the disclosure, a method, a computer-readable medium, and a computer system are provided. The computer system includes one or more computing devices. The one or more computing devices select a pre-existing model from a plurality of pre-existing models stored in a cloud platform. The one or more computing devices configure a data collector to collect specific data points from one or more target devices. The one or more computing devices train the pre-existing model using the collected specific data points to generate a micro-model optimized for a specific use case. The one or more computing devices optimize the micro-model to reduce a size of the micro-model. The one or more computing devices deploy the optimized micro-model to an inference co-processor associated with at least one of the one or more target devices.

### BACKGROUND

### Field

The present disclosure relates generally to computer systems, and more particularly, to techniques of developing, training, and deploying resource-efficient artificial intelligence micro-models.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

The proliferation of Artificial Intelligence (AI) and Machine Learning (ML) has driven significant advancements in managing complex computing environments, such as data centers and distributed systems. Traditionally, system management relied heavily on monitoring sensor data (e.g., temperature, voltage, fan speed via components like Baseboard Management Controllers or BMCs), log analysis, and predefined rule-based systems to maintain operational health and predict potential issues. While effective to a degree, these methods often lack the predictive power and adaptability of modern AI models, which can uncover subtle patterns and correlations in vast datasets to anticipate failures, optimize resource allocation, or automate complex responses with greater accuracy. However, integrating sophisticated AI capabilities directly into system management infrastructure presented substantial hurdles.

A primary challenge stemmed from the inherent resource constraints of many management components, particularly embedded systems like BMCs, BIOS/UEFI firmware environments, or various Internet of Things (IoT) devices deployed at the edge. These devices typically possess limited processing power, memory (RAM), and non-volatile storage compared to host systems or cloud servers. Concurrently, state-of-the-art AI models, especially deep learning networks, often demand significant computational resources and memory footprints for both training and inference (execution). This mismatch made it impractical or impossible to deploy large, general-purpose AI models directly onto these resource-constrained platforms. While cloud-based AI processing was an alternative, it introduced latency, dependency on network connectivity, and potential data privacy concerns, making localized inference highly desirable for real-time decision-making at the edge.

Furthermore, the diverse nature of system management tasks necessitates specialized AI solutions rather than a single, monolithic model. For example, predicting thermal issues requires different data and model architecture than classifying network traffic for security threats or forecasting storage device lifespan.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a computer system are provided. The computer system includes one or more computing devices. The one or more computing devices select a pre-existing model from a plurality of pre-existing models stored in a cloud platform. The one or more computing devices configure a data collector to collect specific data points from one or more target devices. The one or more computing devices train the pre-existing model using the collected specific data points to generate a micro-model optimized for a specific use case. The one or more computing devices optimize the micro-model to reduce a size of the micro-model. The one or more computing devices deploy the optimized micro-model to an inference co-processor associated with at least one of the one or more target devices.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller (BMC) and a host computer.

FIG. 2 is a diagram illustrating a system architecture for developing, training, and deploying micro-models on embedded devices.

FIG. 3 is a diagram illustrating a system architecture focused on the deployment and execution of micro-models within an embedded ecosystem.

FIG. 4 is a flow chart of a method for developing and deploying micro-models.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

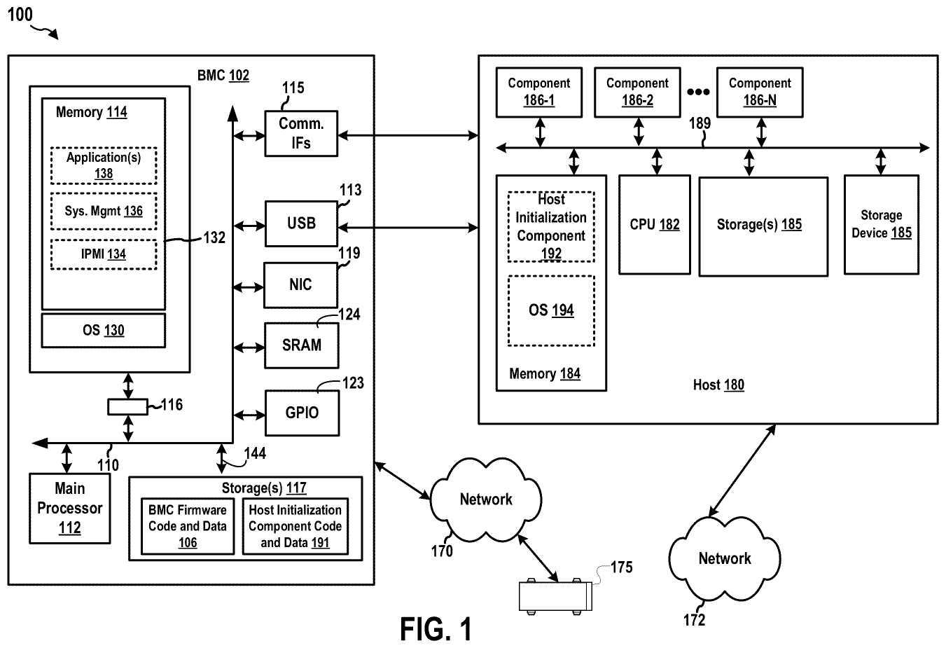

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170. Further, the storage(s) 117 is in communication with the communication channel 110 through a communication link 144.

Artificial intelligence (AI) models offer significant potential for enhancing the management and operation of computer systems, such as the server environment depicted in FIG. 1. However, deploying these AI models effectively presents several challenges, particularly within complex ecosystems like data centers and on resource-constrained embedded devices such as the Baseboard Management Controller (BMC) 102. A primary challenge relates to the size of AI models. Many sophisticated models require substantial memory and computational resources, making them difficult to deploy directly onto devices with limited capabilities.

Furthermore, there is no single, universal AI model optimized for the diverse range of tasks required in system management. For instance, within a data center environment utilizing systems like the computer system 100, distinct AI models might be needed for predictive failure analysis (e.g., anticipating failures in component devices 186-1 to 186-N based on sensor data monitored by the BMC 102), classification of workloads running on the host computer 180, generation of automated actions or recommendations based on specific stimuli (e.g., adjusting fan speeds based on temperature and workload), or creating data visualizations for administrators. Supporting these varied use cases necessitates the development, training, and deployment of multiple, specialized AI models, each tailored to its specific purpose and trained on relevant datasets. Managing a collection of potentially interdependent AI models adds another layer of complexity.

These challenges become particularly acute when considering deployment on edge or embedded systems, such as the BMC 102. The BMC 102, while capable of managing the host computer 180, typically operates with limited processing power (main processor 112), memory (memory 114), and storage (storage(s) 117) compared to the host computer 180 or dedicated AI processing hardware. Large, general-purpose AI models, such as large language models (LLMs) or complex deep learning networks, often exceed the resource constraints of such embedded environments. Moreover, for many specific management tasks performed by or relevant to the BMC 102 (e.g., monitoring temperature sensors, predicting component lifecycles based on operational parameters), a smaller model trained specifically on pertinent data (like telemetry data collected by the BMC 102) can provide more accurate and efficient results than a large, generic model. Therefore, a need exists for an approach to develop, manage, and deploy appropriately sized, use-case-specific AI models (referred to herein as micro-models) within environments containing resource-constrained devices like BMCs, enabling AI-driven insights and automation at the edge. This involves addressing how to train these models efficiently, potentially leveraging a central cloud platform with greater resources, and subsequently deploying the resulting compact micro-models onto target embedded systems for inference.

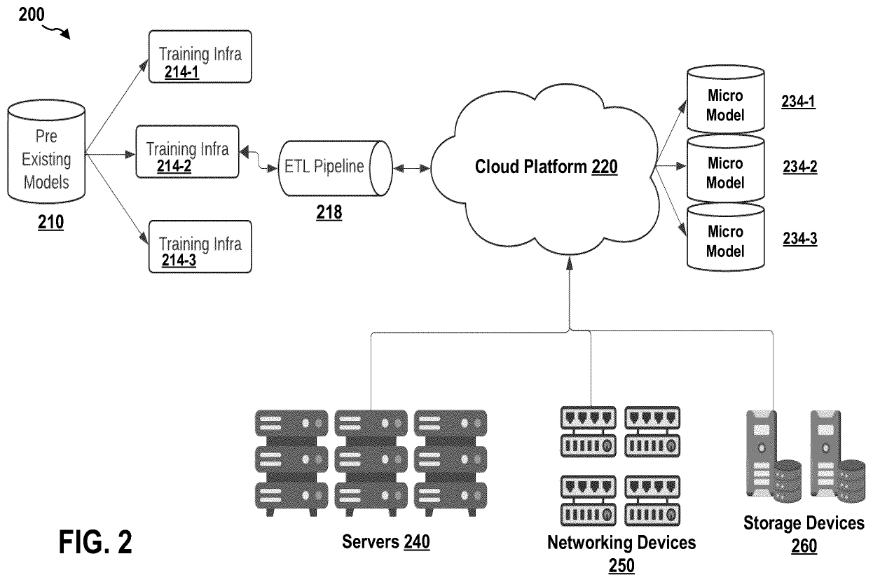

FIG. 2 is a diagram illustrating a system architecture 200 for developing, training, and deploying micro-models on embedded devices. The system architecture 200 provides a framework for creating specialized, resource-efficient AI models that can operate within the constraints of devices such as the BMC 102 described in FIG. 1.

The system architecture 200 utilizes pre-existing models 210, which serve as base templates for various AI applications. These pre-existing models 210 include different model architectures suited for specific tasks such as regression, classification, image recognition, or predictive analytics. Rather than developing models from scratch for each use case, the system leverages these pre-existing models 210 as starting points that can be specialized and optimized.

The system includes multiple instances of training infrastructure (214-1, 214-2, 214-3) that interface with the pre-existing models 210. Each training infrastructure instance is designed to specialize in training specific types of models. For example, the training infrastructure 214-1 might focus on models for temperature prediction, the training infrastructure 214-2 could specialize in workload classification, and the training infrastructure 214-3 might handle component failure prediction. This modular approach allows for parallel development of different model types and maintains separation of concerns within the training pipeline.

The architecture further includes an ETL (Extract, Transform, Load) pipeline 218, which serves as a data processing conduit between the training infrastructure and external data sources. The ETL pipeline 218 is responsible for collecting relevant data from various endpoints, cleaning and preprocessing this data, and formatting it appropriately for model training. Administrators can configure the ETL pipeline 218 to select specific data fields relevant to their use cases, thereby focusing the training on pertinent information and reducing model complexity. This selective data collection is focused on micro-models rather than general-purpose models that require extensive data and computational resources.

A cloud platform 220 orchestrates the entire process, providing the computational resources necessary for model training that would be unavailable on embedded devices. The cloud platform 220 can be deployed either as a public cloud service or as a private on-premises solution within a customer's network, offering flexibility in deployment based on security requirements, data sensitivity, and connectivity constraints. When deployed on-premises, the cloud platform 220 can discover and connect to devices within the network, such as the BMC 102 described in FIG. 1, to facilitate data collection and model deployment.

The output of the training process is a collection of micro-models (234-1, 234-2, 234-3) that are optimized for specific use cases and constrained environments. These micro-models are substantially smaller than general-purpose AI models, making them suitable for deployment on devices with limited memory and processing capabilities. For example, the micro-model 234-1 might be specialized for temperature prediction, the micro-model 234-2 for workload optimization, and the micro-model 234-3 for component lifecycle management. Each micro-model is focused on a narrow task, enabling high performance within its specific domain while maintaining a small footprint.

The deployment environments for these micro-models may include servers 240, networking devices 250, and storage devices 260. Each of these environments has unique constraints and requirements. For instance, the servers 240 might require models related to temperature management and workload prediction, the networking devices 250 might need models for packet analysis and security threat detection, and the storage devices 260 might benefit from models that predict drive failures or optimize data placement. The micro-models, once trained and optimized in the cloud platform 220, can be deployed to these environments via REST APIs or similar mechanisms.

In operation, data flows from the servers 240, networking devices 250, and storage devices 260 to the cloud platform 220, potentially through the ETL pipeline 218 for preprocessing. This data is used to train or fine-tune the micro-models using the appropriate training infrastructure (214-1, 214-2, 214-3) based on the specific use case. Once trained, the resulting micro-models (234-1, 234-2, 234-3) are stored in the cloud platform 220 and can be deployed back to the originating devices or to other similar devices within the network.

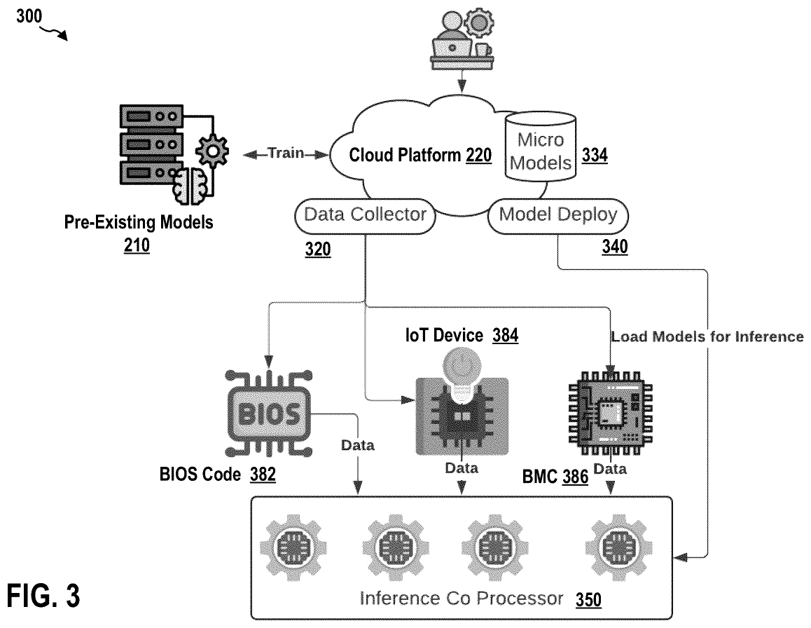

FIG. 3 is a diagram illustrating a system architecture 300 focused on the deployment and execution of micro-models within an embedded ecosystem. The cloud platform 220 serves as the hub for managing the lifecycle of micro-models. The cloud platform 220 utilizes the pre-existing models 210 as foundational templates, which are trained using data collected from various sources to generate specialized micro-models 334. An administrator or user interacts with the cloud platform 220 to configure data collection, select models for training, and manage deployment.

The cloud platform 220 includes a data collector 320 component responsible for gathering relevant data from target devices. In this example, these devices can include systems running BIOS code 382 (analogous to the initialization component 192 executed by the host CPU 182 using code stored on the BMC 102), dedicated IoT devices 384, and BMCs 386 (such as the BMC 102 described in FIG. 1). The data collector 320 allows for selective gathering of specific parameters pertinent to the intended function of the micro-model, avoiding the collection of unnecessary telemetry data and helping to keep the resulting models compact.

Once trained and optimized within the cloud platform 220 (using infrastructure similar to that shown in FIG. 2), the resulting micro-models 334 are stored, potentially in a library or marketplace accessible via the platform. A model deployment component 340 within the cloud platform 220 handles the distribution and loading of selected micro-models 334 onto a designated execution environment.

The execution environment for the micro-models is represented by inference co-processors 350. A inference co-processor 350 is a processing unit capable of running AI inference tasks using the deployed micro-models. The inference co-processor 350 can be implemented in various ways: it could be integrated within the BMC 386 itself if the BMC possesses sufficient resources, it could be the main CPU of a host system (like the host CPU 182), a dedicated co-processor chip on the same board as the BMC, or even an external device like a Raspberry Pi connected to the system. The model deployment component 340 loads the chosen micro-models onto this inference co-processor 350.

In operation, real-time data is fed from the source devices (the BIOS code 382, the IoT device 384, the BMC 386) directly to the inference co-processor 350. The inference co-processor 350 then applies the loaded micro-models to this incoming data stream to perform inference tasks, such as predicting failures, classifying workloads, detecting anomalies, or generating insights specific to the micro-model's purpose. This architecture enables AI-driven analysis and decision-making directly on or near the edge devices, utilizing compact, specialized micro-models trained in the cloud but executed locally with minimal resource requirements.

A code implementation example is described infra, demonstrating the process of training a temperature sensor breach prediction micro-model in the cloud platform 220 and its subsequent deployment for inference on an embedded device.

The first segment of the code example defines and trains the model within the cloud platform 220. The model is structured as a sequential neural network with multiple layers:

# Define model
model = tf.keras.Sequential([
tf.keras.layers.Input(shape=(4,)), # 4 input features: time, load,
# ambient_temp, current_temp
tf.keras.layers.Dense(16, activation=‘relu’),
tf.keras.layers.Dense(8, activation=‘relu’),
tf.keras.layers.Dense(1, activation=‘sigmoid’)
])
# Compile model
model.compile(optimizer=‘adam’, loss=‘binary_crossentropy’,
metrics=[‘accuracy’])
# Train model
history = model.fit(X_train_scaled, y_train, epochs=50, batch_size=32,
validation_split=0.2, verbose=0)

This model takes four input features: time (represented as hours in a day), system load, ambient temperature, and current temperature. These inputs are processed through two hidden layers with ReLU activation functions, followed by a sigmoid output layer that predicts the probability of a temperature breach. The model is trained using the Adam optimizer and binary cross-entropy loss function, which is appropriate for this binary classification task.

After training, the model is converted to a more compact format suitable for deployment on embedded devices:

# Convert to TFLite
converter = tf.lite.TFLiteConverter.from_keras_model(model)
tflite_model = converter.convert( )
# Quantize model
converter.optimizations = [tf.lite.Optimize.DEFAULT]
quantized_tflite_model = converter.convert( )
# Save models
with open(‘server_temp_prediction.tflite’, ‘wb’) as f:
f.write(tflite_model)
with open(‘server_temp_prediction_quantized.tflite’, ‘wb’) as f:
f.write(quantized_tflite_model)
print(f“Original model size: {len(tflite_model)} bytes”)
print(f“Quantized model size: {len(quantized_tflite_model)} bytes”)

The model is first converted to TensorFlow Lite format, which is designed for mobile and embedded devices. Then, quantization is applied to further reduce the model size. Quantization decreases the precision of the model's weights, typically from 32-bit floating-point to 8-bit integer representation, significantly reducing memory requirements while maintaining acceptable accuracy. Both the standard TFLite model and the quantized version are saved, with their respective sizes printed for comparison.

The final segment demonstrates how the deployed micro-model is used for inference on the embedded device:

```
def predict_temperature_breach(time, load, ambient_temp, current_temp):
  input_data = np.array([[time % 24, load, ambient_temp, current_temp]])
  input_data_scaled = scaler.transform(input_data)
  interpreter = tf.lite.Interpreter(model_content=tflite_model)
  interpreter.allocate_tensors( )
  input_details = interpreter.get_input_details( )
  output_details = interpreter.get_output_details( )
  interpreter.set_tensor(input_details[0][‘index’],
  input_data_scaled.astype(np.float32))
  interpreter.invoke( )
  output = interpreter.get_tensor(output_details[0][‘index’])
  return output[0][0]
```

This function takes the same four input features used during training. The time value is normalized to a 24-hour cycle, and all inputs are scaled using the same scaler that was applied to the training data. The TFLite interpreter is initialized with the model content, tensors are allocated, and the input data is provided to the model. After invoking the interpreter, the output—representing the probability of a temperature breach—is retrieved and returned.

This implementation example demonstrates the complete workflow from model definition and training in the cloud platform 220 to deployment and inference on an embedded device. The resulting micro-model is compact enough to run on resource-constrained devices such as the BMC 386, yet specialized enough to provide accurate predictions for its specific task of temperature breach prediction.

The system architecture 200 and the system architecture 300 facilitate a workflow managed by an administrator through an interface provided by the cloud platform 220. This workflow enables the creation, deployment, and execution of specialized, resource-efficient AI models, referred to as micro-models (e.g., micro model 234-1, micro model 234-2, micro model 234-3, micro models 334), tailored for specific tasks within environments that may include resource-constrained devices such as the BMC 102, the BMC 386, or the IoT device 384.

Initially, the administrator may select a desired micro-model type from a library or repository hosted within the cloud platform 220. This selection corresponds to choosing one of the pre-existing models 210, which represent base architectures suitable for different AI tasks like prediction, classification, or anomaly detection. For example, an administrator might select a regression model template for predicting temperature fluctuations or a classification model template for identifying workload types. Following model selection, the administrator specifies the data sources required for training this particular model. This involves configuring the data collector 320, potentially in conjunction with the ETL pipeline 218, to gather specific data points from designated endpoints. These endpoints could include the servers 240, the networking devices 250, the storage devices 260, systems executing the BIOS code 382, the IoT device 384, or the BMC 386. The configuration allows the administrator to focus data collection on parameters pertinent to the chosen model's function, such as temperature readings, fan speeds, network packet headers, or storage I/O statistics, thereby avoiding the overhead of collecting and processing irrelevant data.

Once the model type and data sources are defined, the administrator initiates the training process within the cloud platform 220. The cloud platform 220 directs the selected data, processed by the ETL pipeline 218 if configured, to the appropriate training infrastructure (e.g., the training infrastructure 214-1, the training infrastructure 214-2, or the training infrastructure 214-3). Utilizing the computational resources available in the cloud platform 220, the selected pre-existing model 210 is trained using the provided dataset. This training results in a specialized micro model (e.g., one of the micro models 334) tailored to the specific use case and dataset. The cloud platform 220 may also apply optimization techniques, such as quantization (as exemplified by the conversion to TFLite and quantization steps described supra), to significantly reduce the size of the resulting micro model 334, making it suitable for deployment on devices with limited memory and processing power. The trained and optimized micro models 334 are then stored within the cloud platform 220, available for deployment.

The trained micro model 334 may be deployed to a target execution environment. For example, using the interface of the cloud platform 220, the administrator selects the desired micro model 334 and designates a target inference co-processor 350. The model deployment component 340 within the cloud platform 220 manages the transfer and loading of the selected micro model 334 onto the specified inference co-processor 350. The inference co-processor 350 represents the hardware where the model execution (inference) will occur. As described supra, this could be the main processor 112 of the BMC 102 (or BMC 386), the host CPU 182, a dedicated accelerator chip associated with the BMC 386, or an external compute module connected to the system.

Finally, the administrator configures the system to establish a connection between the relevant data sources and the inference co-processor 350 for real-time analysis. Live data streams from the originating devices (e.g., sensor readings from the BMC 386, data from the IoT device 384, or parameters related to the execution environment of the BIOS code 382) are fed directly to the inference co-processor 350. The inference co-processor 350, now equipped with the loaded micro model 334, processes this incoming real-time data to perform inference according to the model's specific function. This allows for localized, low-latency AI-driven analysis, predictions, or classifications directly at the edge, leveraging the compact, specialized micro-models trained in the cloud platform 220.

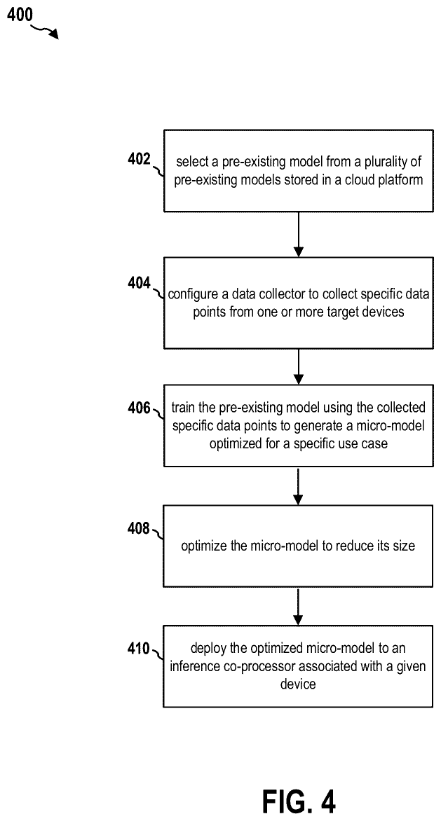

FIG. 4 is a flow chart 400 of a method (process) for developing and deploying micro-models. The method may be performed by one or more computing devices (e.g., components of the cloud platform 220, administrator interfaces, inference co-processors 350).

In operation 402, the one or more computing devices select a pre-existing model from a plurality of pre-existing models stored in a cloud platform. In certain configurations, the plurality of pre-existing models includes different model architectures for different types of machine learning tasks, including at least one of: regression, classification, image recognition, or predictive analytics. In certain configurations, the cloud platform is deployed as one of: a public cloud service or a private on-premises solution within a customer network.

In operation 404, the one or more computing devices configure a data collector to collect specific data points from one or more target devices. In certain configurations, the one or more target devices comprise at least one of a baseboard management controller (BMC), a device running BIOS code, or an Internet of Things (IoT) device. To configure the data collector, the one or more computing devices further select specific parameters relevant to the specific use case from a larger set of available parameters provided by the one or more target devices.

In certain configurations, the one or more computing devices process the collected specific data points through an Extract, Transform, Load (ETL) pipeline prior to training the pre-existing model. The ETL pipeline cleans and formats the collected specific data points.

In operation 406, the one or more computing devices train the pre-existing model using the collected specific data points to generate a micro-model optimized for a specific use case. In certain configurations, the specific use case includes at least one of: temperature prediction, workload classification, component failure prediction, anomaly detection, security threat detection, or power management. To train the pre-existing model, the one or more computing devices further utilize computational resources of the cloud platform to train the pre-existing model, when the computational resources exceed resources available on the one or more target devices.

In operation 408, the one or more computing devices optimize the micro-model to reduce its size. To optimize the micro-model to reduce its size, the one or more computing devices further convert the micro-model to a TensorFlow Lite format and apply quantization to the converted micro-model to reduce memory requirements. In certain configurations, the one or more computing devices store the optimized micro-model in a library within the cloud platform and make the optimized micro-model available for deployment to other target devices with similar use cases.

In operation 410, the one or more computing devices deploy the optimized micro-model to an inference co-processor associated with a given device. In certain configurations, the inference co-processor comprises at least one of: a processor within the target device, a main CPU of a host system connected to the target device, a dedicated co-processor chip, or an external computing device connected to the target device. To deploy the optimized micro-model, the one or more computing devices further transmit the optimized micro-model from the cloud platform to the inference co-processor using a REST API.

In certain configurations, the one or more computing devices establish a connection between the one or more target devices and the inference co-processor for providing real-time data from the one or more target devices to the inference co-processor. The one or more computing devices perform inference on the real-time data using the optimized micro-model deployed on the inference co-processor. To perform inference, the one or more computing devices further receive input data from sensors of the one or more target devices, scale the input data using a scaler that was applied during training of the pre-existing model, provide the scaled input data to the optimized micro-model, and generate a prediction or classification based on the scaled input data.

The various components and processes illustrated in the system architectures of FIGS. 2 and 3, and the method outlined in FIG. 4, can be realized using the hardware elements depicted in the computer system 100 of FIG. 1. Specifically, the host computer 180, equipped with its host CPU 182, host memory 184, storage device(s) 185, and operating system 194, possesses the necessary computational and storage capabilities to implement the functions of the cloud platform 220, particularly in the on-premises deployment scenario mentioned in the disclosure presentation. In such a configuration, the host computer 180 could execute the software responsible for storing pre-existing models 210, managing the training infrastructure (e.g., 214-1, 214-2, 214-3), operating the ETL pipeline 218, coordinating the data collector 320, storing the resulting micro-models (e.g., 234-1, 334), handling model deployment 340, and providing the administrative interface for the entire workflow. Communication for data collection and model deployment may use the network interfaces (e.g., network interface card 119 connecting to network 170 or host network connections via data network 172).

Furthermore, the target devices and inference execution environments described in FIGS. 2 and 3 find direct counterparts within FIG. 1. The BMC 102 itself, with its main processor 112, memory 114, and storage(s) 117, represents a primary example of a resource-constrained embedded system (like BMC 386) targeted for micro-model deployment. The BMC's main processor 112 may serve as the inference co-processor 350, executing optimized micro-models 334 using real-time data collected from its own sensors or via its communication interfaces 115. Alternatively, the host CPU 182 could also function as the inference co-processor 350, running micro-models relevant to host operations.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, the method comprising:
selecting a pre-existing model from a plurality of pre-existing models stored in a cloud platform;
configuring a data collector to collect specific data points from one or more target devices;
training the pre-existing model using the collected specific data points to generate a micro-model optimized for a specific use case;
optimizing the micro-model to reduce a size of the micro-model; and
deploying the optimized micro-model to an inference co-processor associated with a given device.

2. The method of claim 1, wherein the one or more target devices comprise at least one of a baseboard management controller (BMC), a device running BIOS code, or an Internet of Things (IoT) device.

3. The method of claim 1, wherein optimizing the micro-model to reduce its size comprises:
converting the micro-model to a TensorFlow Lite format; and
applying quantization to the converted micro-model to reduce memory requirements.

4. The method of claim 1, wherein the inference co-processor comprises at least one of: a processor within the target device, a main CPU of a host system connected to the target device, a dedicated co-processor chip, or an external computing device connected to the target device.

5. The method of claim 1, further comprising:
establishing a connection between the one or more target devices and the inference co-processor for providing real-time data from the one or more target devices to the inference co-processor; and
performing inference on the real-time data using the optimized micro-model deployed on the inference co-processor.

6. The method of claim 1, wherein configuring the data collector comprises selecting specific parameters relevant to the specific use case from a larger set of available parameters provided by the one or more target devices.

7. The method of claim 1, wherein the cloud platform is deployed as one of: a public cloud service or a private on-premises solution within a customer network.

8. The method of claim 1, further comprising:
processing the collected specific data points through an Extract, Transform, Load (ETL) pipeline prior to training the pre-existing model, wherein the ETL pipeline cleans and formats the collected specific data points.

9. The method of claim 1, wherein the specific use case comprises at least one of: temperature prediction, workload classification, component failure prediction, anomaly detection, security threat detection, or power management.

10. The method of claim 1, wherein the plurality of pre-existing models comprises different model architectures for different types of machine learning tasks, including at least one of: regression, classification, image recognition, or predictive analytics.

11. The method of claim 1, wherein deploying the optimized micro-model comprises:
transmitting the optimized micro-model from the cloud platform to the inference co-processor using a REST API.

12. The method of claim 1, further comprising:
storing the optimized micro-model in a library within the cloud platform; and
making the optimized micro-model available for deployment to other target devices with similar use cases.

13. The method of claim 1, wherein training the pre-existing model comprises:
utilizing computational resources of the cloud platform to train the pre-existing model, wherein the computational resources exceed resources available on the one or more target devices.

14. The method of claim 5, wherein performing inference comprises:
receiving input data from sensors of the one or more target devices;
scaling the input data using a scaler that was applied during training of the pre-existing model;
providing the scaled input data to the optimized micro-model; and
generating a prediction or classification based on the scaled input data.

15. A system, including one or more computing devices, comprising:
a memory; and
at least one processor coupled to the memory and configured to:
select a pre-existing model from a plurality of pre-existing models stored in a cloud platform;
configure a data collector to collect specific data points from one or more target devices;
train the pre-existing model using the collected specific data points to generate a micro-model optimized for a specific use case;
optimize the micro-model to reduce a size of the micro-model; and
deploy the optimized micro-model to an inference co-processor associated with a given device.

16. The system of claim 15, wherein the one or more target devices comprise at least one of a baseboard management controller (BMC), a device running BIOS code, or an Internet of Things (IoT) device.

17. The system of claim 15, wherein to optimize the micro-model to reduce its size, the at least one processor is configured to:
convert the micro-model to a TensorFlow Lite format; and
apply quantization to the converted micro-model to reduce memory requirements.

18. The system of claim 15, wherein the inference co-processor comprises at least one of: a processor within the target device, a main CPU of a host system connected to the target device, a dedicated co-processor chip, or an external computing device connected to the target device.

19. The system of claim 15, wherein the at least one processor is further configured to:
establish a connection between the one or more target devices and the inference co-processor for providing real-time data from the one or more target devices to the inference co-processor; and
perform inference on the real-time data using the optimized micro-model deployed on the inference co-processor.

20. A non-transitory computer-readable medium storing computer executable code for operating one or more computing devices, comprising code to:
select a pre-existing model from a plurality of pre-existing models stored in a cloud platform;
configure a data collector to collect specific data points from one or more target devices;
train the pre-existing model using the collected specific data points to generate a micro-model optimized for a specific use case;
optimize the micro-model to reduce a size of the micro-model; and
deploy the optimized micro-model to an inference co-processor associated with a given device.
